(19) United States
(12) Patent Application Publication
(10) Pub. No.: US 2006/0072740 A1
(43) Pub. Date: Apr. 6, 2006

(54) Selective analog signal sensing from a plurality of integrated circuits using a common node

(76) Inventors: Ion C. Tesu, Austin, TX (US); Michael J. Mills, Austin, TX (US)

Correspondence Address: DAVIS & ASSOCIATES, P.O. BOX 1093, DRIPPING SPRINGS, TX, 78620, US

(21) Appl. No.: 10/955,000

(22) Filed: Sep. 30, 2004

(51) Int. Cl. H04M 1/00

(52) U.S. Cl. 379/399.01; 379/387.01

(57) ABSTRACT

A first integrated circuit generates one or more control signals to couple a select one of a plurality of nodes of a plurality of second integrated circuits to a common input node for the first integrated circuit. The first integrated circuit senses an analog signal at the common input node based on a signal at the coupled select node.

### BACKGROUND

Subscriber line (or loop) interface circuitry (SLIC) may be found in or near a central office exchange of a telecommunications network.

One SLIC provides a communications interface between a digital switching network for a central office exchange and an analog subscriber line. The analog subscriber line connects to subscriber equipment, such as a subscriber station or telephonic instrument for example, at a location remote from the central office exchange. The analog subscriber line and subscriber equipment form a subscriber loop.

The SLIC detects and transforms voiceband communications transmitted from the subscriber equipment in the form of low voltage analog signals on the subscriber loop into corresponding digital data for transmission to the digital switching network. For bi-directional communication, the SLIC also transforms digital data received from the digital switching network into corresponding low voltage analog signals for transmission on the subscriber loop to the subscriber equipment.

The SLIC typically uses different power supply levels depending on its operation state. The SLIC may use, for example, one supply level when the subscriber equipment is deactivated or on-hook, another supply level when the subscriber equipment is activated or off-hook, and yet another supply level to signal or ring the subscriber equipment for call progress.

The SLIC may be supplied with power at a fixed or constant supply level sufficient to meet the maximum amount of power required by the load on the subscriber loop. The SLIC, however, would then have to be designed to dissipate the extra power when the SLIC is in an operation state in which the power required by the load is smaller than the power supplied to the SLIC.

One SLIC selectively switches between different power supplies based on the operation state of the SLIC and/or the voltage across the subscriber loop. Another SLIC controls a direct-current to direct-current (DC-DC) converter to supply power to the SLIC at different voltage levels. Such SLICs may then help reduce or minimize any excess power by helping to change the voltage supplied to the SLIC as the SLIC changes its power usage. Such SLICs monitor the amount of power supplied to the SLIC to help monitor and control voltage and current on the subscriber loop and to help protect the SLIC from excessive power dissipation and thermal overload conditions.

### SUMMARY

One disclosed method comprises generating by a first integrated circuit one or more control signals to couple a select one of a plurality of nodes of a plurality of second integrated circuits to a common input node for the first integrated circuit and sensing by the first integrated circuit an analog signal at the common input node based on a signal at the coupled select node.

One disclosed integrated circuit comprises control circuitry to generate and output one or more control signals to couple a select one of a plurality of nodes of a plurality of other integrated circuits to a common input node and sensing circuitry to sense an analog signal at the common input node based on a signal at the coupled select node.

One disclosed system comprises a first integrated circuit and a plurality of second integrated circuits coupled to the first integrated circuit. The first integrated circuit comprises control circuitry to generate and output one or more control signals to couple a select node of one of the plurality of second integrated circuits to a common input node and sensing circuitry to sense an analog signal at the common input node based on a signal at the coupled select node. The one second integrated circuit comprises circuitry to couple the select node to the common input node in response to the one or more control signals.

### BRIEF DESCRIPTION OF THE DRAWINGS

One or more described embodiments are illustrated by way of example and not limitation in the figures of the accompanying drawings, in which like references indicate similar elements and in which:

FIG. 1 illustrates, for one or more embodiments, a system having selective analog signal sensing from a plurality of integrated circuits using a common node;

FIG. 2 illustrates, for one or more embodiments, a flow diagram for a first integrated circuit to sense an analog signal at a common input node based on a signal at a select one of a plurality of nodes of a plurality of second integrated circuits;

FIG. 3 illustrates, for one or more embodiments, a flow diagram for a second integrated circuit to couple a node of the second integrated circuit to a common input node for a first integrated circuit;

FIG. 4 illustrates, for one or more other embodiments, a system having selective analog signal sensing from a plurality of integrated circuits using a common node;

FIG. 5 illustrates, for one or more other embodiments, a system having selective analog signal sensing from a plurality of integrated circuits using a common node;

FIG. 6 illustrates, for one or more embodiments, a flow diagram for a first integrated circuit to repeat sensing an analog signal at a common input node based on a signal at a select one of a plurality of nodes of a plurality of second integrated circuits; and

FIG. 7 illustrates, for one or more embodiments, a system having selective analog signal sensing from a plurality of linefeed interface integrated circuits using a common input node for a subscriber line interface circuitry (SLIC) integrated circuit.

### DETAILED DESCRIPTION

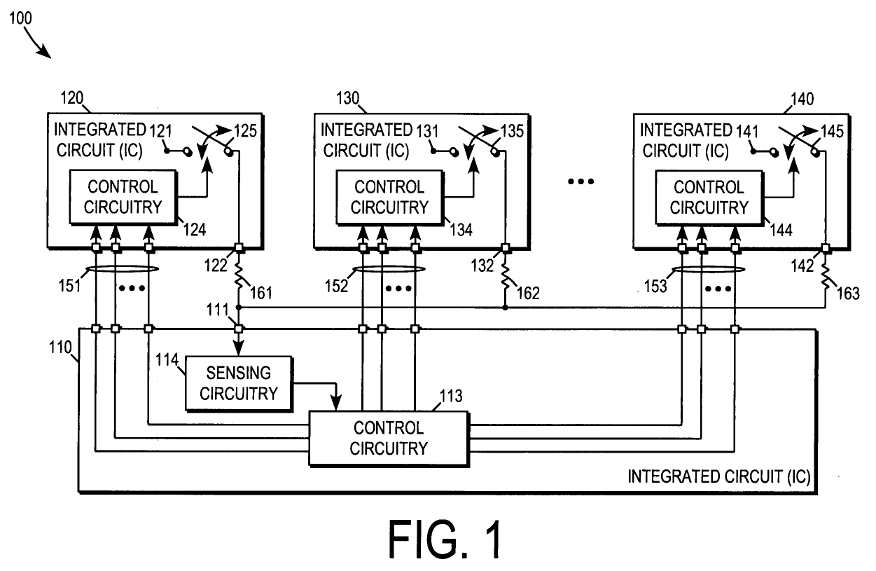

FIG. 1 illustrates, for one or more embodiments, a system 100 comprising an integrated circuit 110 coupled to a plurality of other integrated circuits 120, 130, and 140. Integrated circuits 110, 120, 130, and 140 may comprise any suitable circuitry to perform any suitable one or more functions.

Integrated circuit 110 for one or more embodiments may comprise any suitable circuitry to help selectively sense one or more of a plurality of nodes of integrated circuits 120, 130, and 140 using a common input node 111 for integrated circuit 110. Integrated circuits 110, 120, 130, and 140 may be coupled either directly or indirectly to common input node 111 in any suitable manner. By using a common input node 111 to sense one or more of a plurality of nodes of integrated circuits 120, 130, and 140, integrated circuit 110 for one or more embodiments may be designed with relatively fewer contact pads and/or pins as common input node 111 may be defined with only one contact pad and/or one pin.

Integrated circuit 110 may help sense any suitable one or more nodes of integrated circuit 120, 130, and/or 140 to help identify any suitable characteristic of integrated circuit 120, 130, and/or 140 for any suitable purpose. As one example, integrated circuit 110 for one or more embodiments as illustrated in FIG. 1 may help selectively sense a node 121 of integrated circuit 120, a node 131 of integrated circuit 130, and/or a node 141 of integrated circuit 140. Integrated circuit 110 for one or more embodiments may help sense any suitable one or more nodes of integrated circuit 120, 130, and/or 140 to help identify a voltage level at one or more nodes of integrated circuit 120, 130, and/or 140. Integrated circuit 110 for one or more embodiments may help sense any suitable one or more nodes of integrated circuit 120, 130, and/or 140 to help identify the amount of current flowing through one or more branches of integrated circuit 120, 130, and/or 140. Integrated circuit 110 for one or more embodiments may help sense any suitable one or more nodes of integrated circuit 120, 130, and/or 140 to help identify the amount of power being supplied to integrated circuit 120, 130, and/or 140. Integrated circuit 110 for one or more embodiments may help control one or more of integrated circuits 120, 130, and 140 in response to sensing one or more nodes of integrated circuit 120; 130, and/or 140.

Although described and illustrated as being coupled to help sense nodes of three integrated circuits 120, 130, and 140, integrated circuit 110 may be coupled to help sense nodes of any suitable number of integrated circuits such as, for example, two, four, or more.

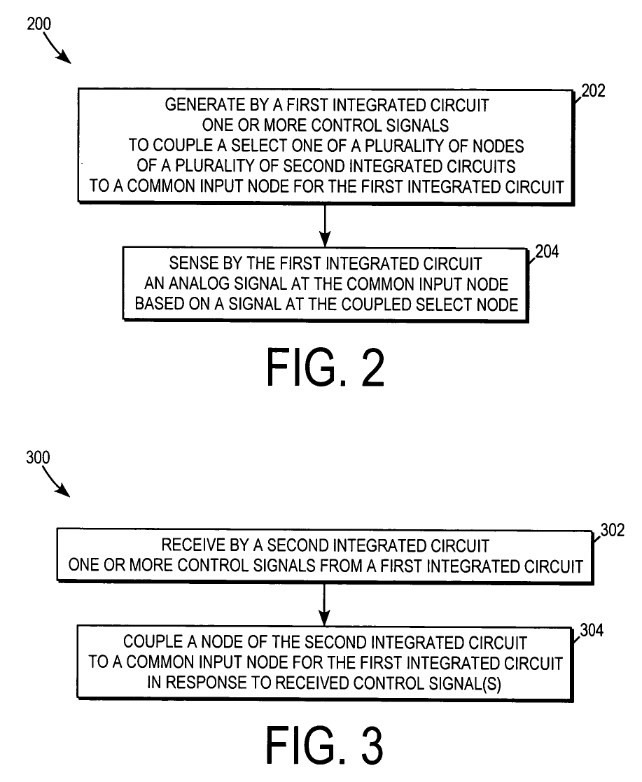

Integrated circuit 110 may help sense one or more nodes using common input node 111 in any suitable manner. Integrated circuit 110 for one or more embodiments may help sense one or more nodes using common input node 111 in accordance with a flow diagram 200 of FIG. 2.

For block 202 of FIG. 2, integrated circuit 110 generates one or more control signals to couple a select node of integrated circuit 120, 130, or 140 to common input node 111. Integrated circuit 110 may comprise any suitable circuitry to generate any suitable one or more control signals to couple a select node of integrated circuit 120, 130, or 140 to common input node 111 in any suitable manner.

Integrated circuit 110 for one or more embodiments, as illustrated in FIG. 1, may comprise control circuitry 113 to generate such control signal(s). Control circuitry 113 may comprise any suitable circuitry to generate such control signal(s) in any suitable manner. Control circuitry 113 for one or more embodiments may generate and output one or more control signals over one or more control lines coupled to integrated circuit 120 to couple a node of integrated circuit 120 to common input node 111. Control circuitry 113 for one or more embodiments may generate and output one or more control signals over one or more control lines coupled to integrated circuit 130 to couple a node of integrated circuit 130 to common input node 111. Control circuitry 113 for one or more embodiments may generate and output one or more control signals over one or more control lines coupled to integrated circuit 140 to couple a node of integrated circuit 140 to common input node 111. As illustrated in FIG. 1, control circuitry 113 for one embodiment may be coupled to integrated circuit 120 by a plurality of control lines 151, may be coupled to integrated circuit 130 by a plurality of control lines 152, and may be coupled to integrated circuit 140 by a plurality of control lines 153. Control circuitry 113 for one or more other embodiments may generate and output one or more control signals over one or more shared control lines coupled to at least two of integrated circuits 120, 130, and 140.

For block 204 of FIG. 2, integrated circuit 110 senses an analog signal at common input node 111 based on a signal at the select node coupled to common input node 111 for block 202. Integrated circuit 110 may comprise any suitable circuitry to sense an analog signal at common input node 111 in any suitable manner.

Integrated circuit 110 for one or more embodiments, as illustrated in FIG. 1, may comprise sensing circuitry 114 coupled to common input node 111 to sense an analog signal at common input node 111. Sensing circuitry 114 may comprise any suitable circuitry to sense an analog signal at common input node 111 in any suitable manner. Sensing circuitry 114 for one or more embodiments may comprise any suitable circuitry to sense a voltage at common input node 111. Sensing circuitry 114 for one or more embodiments may comprise any suitable circuitry to sense a current flowing into or out from common input node 111.

For one or more embodiments, one or more nodes of integrated circuit 120, 130, and/or 140 may be coupled to common input node 111 through one or more resistive elements or components to help scale the signal at such a node when coupled to common input node 111. Integrated circuit 110 for one or more embodiments may then effectively sense the signal at such a node when coupled to common input node 111 by sensing the scaled signal at common input node 111. Scaling the signal to be sensed by integrated circuit 110 for one or more embodiments may help allow integrated circuit 110 to be designed with reduced concern for power dissipation and/or may help allow integrated circuit 110 to be designed to operate with lower power supply voltage levels relative to integrated circuit 120, 130, and/or 140. Integrated circuit 110 for one or more embodiments may be a low voltage integrated circuit relative to integrated circuit 120, 130, and/or 140, and integrated circuit 120, 130, and/or 140 for one or more embodiments may be a high voltage integrated circuit relative to integrated circuit 110.

System 100 for one or more embodiments may comprise one or more resistors between one or more output nodes of one or more of integrated circuits 120, 130, and 140 and common input node 111 to help scale the signal to be sensed by integrated circuit 110. As one example, system 100 for one or more embodiments as illustrated in FIG. 1 may comprise a resistor 161 coupled between common input node 111 and an output node 122 to which node 121 may be selectively coupled, a resistor 162 coupled between common input node 111 and an output node 132 to which node 131 may be selectively coupled, and a resistor 163 coupled between common input node 111 and an output node 142 to which node 141 may be selectively coupled. System 100 for one or more other embodiments may comprise, in addition to or in lieu of resistors 161, 162, and/or 163, one or more resistors having one end coupled in common to output nodes 122, 132, and/or 142 and another end coupled to common input node 111.

Sensing circuitry 114 for one or more embodiments may be coupled to control circuitry 113 to transmit to control circuitry 113 any suitable one or more signals describing the sensed analog signal, any suitable one or more signals identifying whether the sensed analog signal satisfies any suitable one or more predetermined conditions, and/or any suitable one or more signals identifying that an analog signal has been sensed. Sensing circuitry 114 for one or more embodiments may comprise any suitable analog-to-digital converter (ADC) circuitry to convert the analog signal at common input node 111 to one or more digital signals.

Integrated circuits 120, 130, and/or 140 may help selectively couple any suitable node to common input node 111 in any suitable manner. Integrated circuits 120, 130, and/or 140 for one or more embodiments may help selectively couple any suitable node to common input node 111 in accordance with a flow diagram 300 of FIG. 3.

For block 302 of FIG. 3, integrated circuit 120, for example, receives one or more control signals from integrated circuit 110. Integrated circuit 120 may comprise any suitable circuitry to receive one or more control signals from integrated circuit 110 in any suitable manner.

Integrated circuit 120 for one or more embodiments, as illustrated in FIG. 1, may comprise control circuitry 124 coupled to receive such control signal(s). Control circuitry 124 may comprise any suitable circuitry to receive such control signal(s) in any suitable manner.

For block 304 of FIG. 3, integrated circuit 120 couples a node of integrated circuit 120 to common input node 111 in response to received control signal(s). Integrated circuit 120 may comprise any suitable circuitry to couple any suitable node of integrated circuit 120 to common input node 111 in any suitable manner in response to received control signal(s).

Integrated circuit 120 for one or more embodiments may comprise a switch coupled between a node that may be sensed and an output node coupled to common input node 111. Integrated circuit 120 may comprise any suitable circuitry to activate the switch for the node to be sensed in any suitable manner in response to received control signal(s) to couple that node to common input node 111. Such a switch may be implemented in any suitable manner. As one example, such a switch may be implemented using a suitable field effect transistor (FET).

As one example, integrated circuit 120 for one or more embodiments as illustrated in FIG. 1 may comprise a switch 125 coupled between node 121 and output node 122. Control circuitry 124 for one or more embodiments may comprise any suitable circuitry coupled to activate switch 125 in response to control signal(s) received from integrated circuit 110 to couple node 121 to common input node 111.

For one or more embodiments as illustrated in FIG. 1, integrated circuit 130 may comprise control circuitry 134 coupled to receive one or more control signals from integrated circuit 110 and a switch 135 coupled between node 131 and output node 132. Control circuitry 134 for one or more embodiments may comprise any suitable circuitry coupled to activate switch 135 in response to control signal(s) received from integrated circuit 110 to couple node 131 to common input node 111.

For one or more embodiments as illustrated in FIG. 1, integrated circuit 140 may comprise control circuitry 144 coupled to receive one or more control signals from integrated circuit 110 and a switch 145 coupled between node 141 and output node 142. Control circuitry 144 for one or more embodiments may comprise any suitable circuitry coupled to activate switch 145 in response to control signal(s) received from integrated circuit 110 to couple node 141 to common input node 111.

Integrated circuit 120, 130, and/or 140 for one or more embodiments may have a common output node coupled to common input node 111 to help selectively couple one of a plurality of nodes of the integrated circuit to common input node 111 in accordance with flow diagram 300 of FIG. 3.

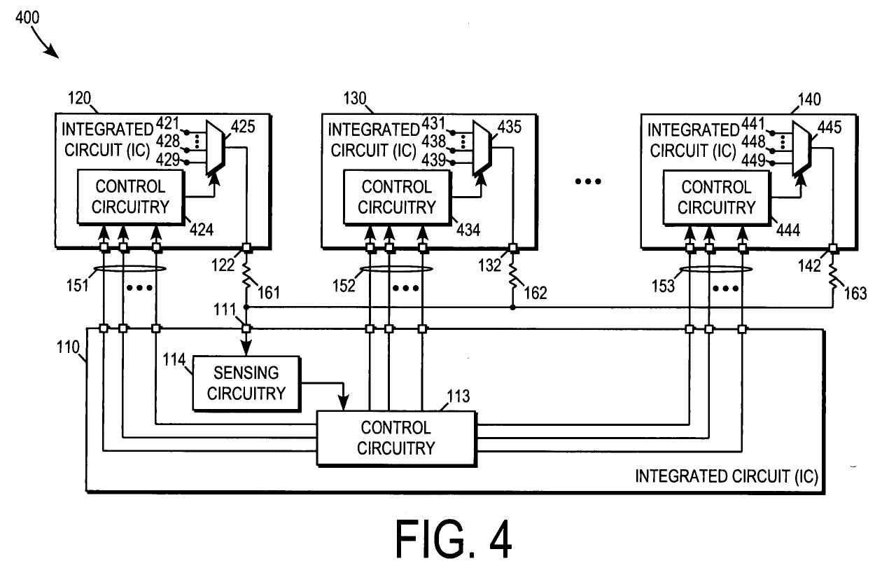

As one example, integrated circuit 120 for one or more embodiments as illustrated in a system 400 of FIG. 4 may comprise control circuitry 424 coupled to receive one or more control signals from integrated circuit 110 and a multiplexer 425 coupled between a set of nodes 421, 428, and 429, for example, and output node 122. Control circuitry 424 for one or more embodiments may comprise any suitable circuitry coupled to control multiplexer 425 in response to such received control signal(s) to help selectively couple one node in the set of nodes to output node 122 and therefore to common input node 111. Control circuitry 424 for one or more embodiments may control multiplexer 425 to couple to common input node 111 a node selected in accordance with received control signal(s). Control circuitry 424 for one or more embodiments may control multiplexer 425 to couple to common input node 111 a node selected in accordance with a predetermined scheme.

For one or more embodiments as illustrated in system 400 of FIG. 4, integrated circuit 130 may comprise control circuitry 434 coupled to receive one or more control signals from integrated circuit 110 and a multiplexer 435 coupled between a set of nodes 431, 438, and 439, for example, and output node 132. Control circuitry 434 for one or more embodiments may comprise any suitable circuitry coupled to control multiplexer 435 in response to such received control signal(s) to help selectively couple one node in the set of nodes to output node 132 and therefore to common input node 111. Control circuitry 434 for one or more embodiments may control multiplexer 435 to couple to common input node 111 a node selected in accordance with received control signal(s). Control circuitry 434 for one or more embodiments may control multiplexer 435 to couple to common input node 111 a node selected in accordance with a predetermined scheme.

For one or more embodiments as illustrated in system 400 of FIG. 4, integrated circuit 140 may comprise control circuitry 444 coupled to receive one or more control signals from integrated circuit 110 and a multiplexer 445 coupled between a set of nodes 441, 448, and 449, for example, and output node 142. Control circuitry 444 for one or more embodiments may comprise any suitable circuitry coupled to control multiplexer 445 in response to such received control signal(s) to help selectively couple one node in the set of nodes to output node 142 and therefore to common input node 111. Control circuitry 444 for one or more embodiments may control multiplexer 445 to couple to common input node 111 a node selected in accordance with received control signal(s). Control circuitry 444 for one or more embodiments may control multiplexer 445 to couple to common input node 111 a node selected in accordance with a predetermined scheme.

Integrated circuit 120, 130, and/or 140 for one or more embodiments may have more than one output node coupled to common input node 111 to help selectively couple one of a plurality of nodes of the integrated circuit to common input node 111 in accordance with flow diagram 300 of FIG. 3.

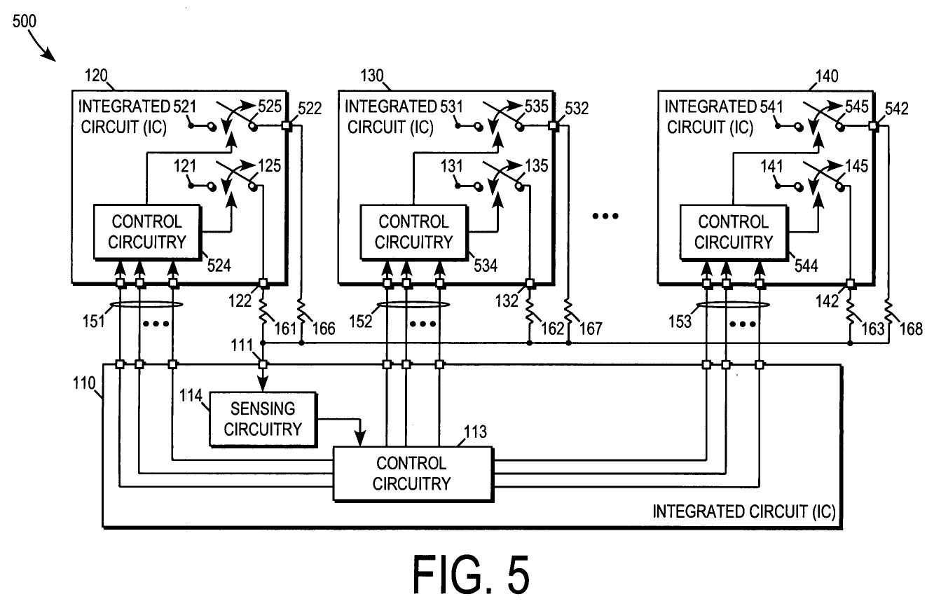

As one example, integrated circuit 120 for one or more embodiments as illustrated in a system 500 of FIG. 5 may comprise control circuitry 524 coupled to receive one or more control signals from integrated circuit 110, switch 125 coupled between node 121 and output node 122, and another switch 525 coupled between a node 521 and an output node 522 coupled to common input node 111. Control circuitry 524 for one or more embodiments may comprise any suitable circuitry coupled to control switches 125 and 525 in response to such received control signal(s) to help selectively couple node 121 to output node 122 and therefore to common input node 111 or to help selectively couple node 521 to output node 522 and therefore to common input node 111. Control circuitry 524 for one or more embodiments may control switches 125 and 525 to couple to common input node 111 a node selected in accordance with received control signal(s). Control circuitry 524 for one or more embodiments may control switches 125 and 525 to couple to common input node 111 a node selected in accordance with a predetermined scheme.

For one or more embodiments as illustrated in system 500 of FIG. 5, integrated circuit 130 may comprise control circuitry 534 coupled to receive one or more control signals from integrated circuit 110, switch 135 coupled between node 131 and output node 132, and another switch 535 coupled between a node 531 and an output node 532 coupled to common input node 111. Control circuitry 534 for one or more embodiments may comprise any suitable circuitry coupled to control switches 135 and 535 in response to such received control signal(s) to help selectively couple node 131 to output node 132 and therefore to common input node 111 or to help selectively couple node 531 to output node 532 and therefore to common input node 111. Control circuitry 534 for one or more embodiments may control switches 135 and 535 to couple to common input node 111 a node selected in accordance with received control signal(s). Control circuitry 534 for one or more embodiments may control switches 135 and 535 to couple to common input node 111 a node selected in accordance with a predetermined scheme.

For one or more embodiments as illustrated in system 500 of FIG. 5, integrated circuit 140 may comprise control circuitry 544 coupled to receive one or more control signals from integrated circuit 110, switch 145 coupled between node 141 and output node 142, and another switch 545 coupled between a node 541 and an output node 542 coupled to common input node 111. Control circuitry 544 for one or more embodiments may comprise any suitable circuitry coupled to control switches 145 and 545 in response to such received control signal(s) to help selectively couple node 141 to output node 142 and therefore to common input node 111 or to help selectively couple node 541 to output node 542 and therefore to common input node 111. Control circuitry 544 for one or more embodiments may control switches 145 and 545 to couple to common input node 111 a node selected in accordance with received control signal(s). Control circuitry 544 for one or more embodiments may control switches 145 and 545 to couple to common input node 111 a node selected in accordance with a predetermined scheme.

System 500 for one or more embodiments may comprise one or more resistors between one or more output nodes of one or more of integrated circuits 120, 130, and 140 and common input node 111 to help scale the signal to be sensed by integrated circuit 110. As one example, system 500 for one or more embodiments as illustrated in FIG. 5 may comprise resistor 161 coupled between common input node 111 and output node 122 to which node 121 may be selectively coupled, a resistor 166 coupled between common input node 111 and output node 522 to which node 521 may be selectively coupled, resistor 162 coupled between common input node 111 and output node 132 to which node 131 may be selectively coupled, a resistor 167 coupled between common input node 111 and output node 532 to which node 531 may be selectively coupled, resistor 163 coupled between common input node 111 and an output node 142 to which node 141 may be selectively coupled, and a resistor 168 coupled between common input node 111 and output node 542 to which node 541 may be selectively coupled. System 500 for one or more other embodiments may comprise, in addition to or in lieu of resistors 161, 162, 163, 166, 167, and/or 168, one or more resistors having one end coupled in common to output nodes 122, 132, 142, 522, 532, and/or 542 and another end coupled to common input node 111.

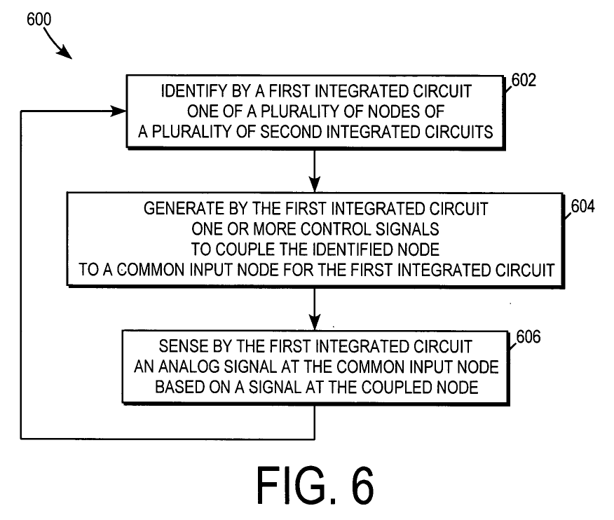

Integrated circuit 110 for one or more embodiments may help repeat sensing one or more nodes of integrated circuit 120, 130, and/or 140 using common input node 111 in any suitable manner. Integrated circuit 110 for one or more embodiments may help repeat sensing one or more nodes using common input node 111 in accordance with a flow diagram 600 of FIG. 6.

For block 602 of FIG. 6, integrated circuit 110 identifies one of a plurality of nodes of integrated circuits 120, 130, and 140. Integrated circuit 110 may identify any suitable one of any suitable plurality of nodes of integrated circuits 120, 130, and 140 in any suitable manner. Integrated circuit 110 for one or more embodiments may selectively identify a node in any suitable manner. Integrated circuit 110 for one or more embodiments may identify a node in accordance with any suitable predetermined scheme.

For block 604, integrated circuit 110 generates one or more control signals to couple the node identified for block 602 to common input node 111. Integrated circuit 110 for one or more embodiments may generate one or more control signals similarly as for block 202 of FIG. 2.

For block 606, integrated circuit 110 senses an analog signal at common input node 111 based on a signal at the node coupled to common input node 111 for block 604. Integrated circuit 110 for one or more embodiments may sense an analog signal at common input node 111 similarly as for block 204 of FIG. 2.

Integrated circuit 110 may repeat operations for blocks 602, 604, and 606 to sense the same node a plurality of times and/or to sense a plurality of nodes of integrated circuit 120, 130, and/or 140 one or more times.

After sensing a given node of a given integrated circuit, integrated circuit 110 for one or more embodiments may identify for block 602 the same given node, generate for block 604 one or more control signals to couple the same given node to common input node 111, and sense for block 606 an analog signal at common input node 111 based on the signal at the same given node.

After sensing a given node of a given integrated circuit, integrated circuit 110 for one or more embodiments may identify for block 602 another node on the same given integrated circuit, generate for block 604 one or more control signals to couple the other node to common input node 111, and sense for block 606 an analog signal at common input node 111 based on the signal at the other node.

After sensing a given node of a given integrated circuit, integrated circuit 110 for one or more embodiments may identify for block 602 another node on another integrated circuit, generate for block 604 one or more control signals to couple the other node to common input node 111, and sense for block 606 an analog signal at common input node 111 based on the signal at the other node.

Integrated circuit 110 for one or more embodiments may repeat operations for blocks 602, 604, and 606 to sense any suitable plurality of nodes of integrated circuit 120, 130, and/or 140 one or more times in accordance with any suitable predetermined scheme. As one example, integrated circuit 110 may sense any suitable plurality of nodes of integrated circuit 120, 130, and/or 140 in a round robin manner.

### SLIC AND LINEFEED INTERFACE INTEGRATED CIRCUITS

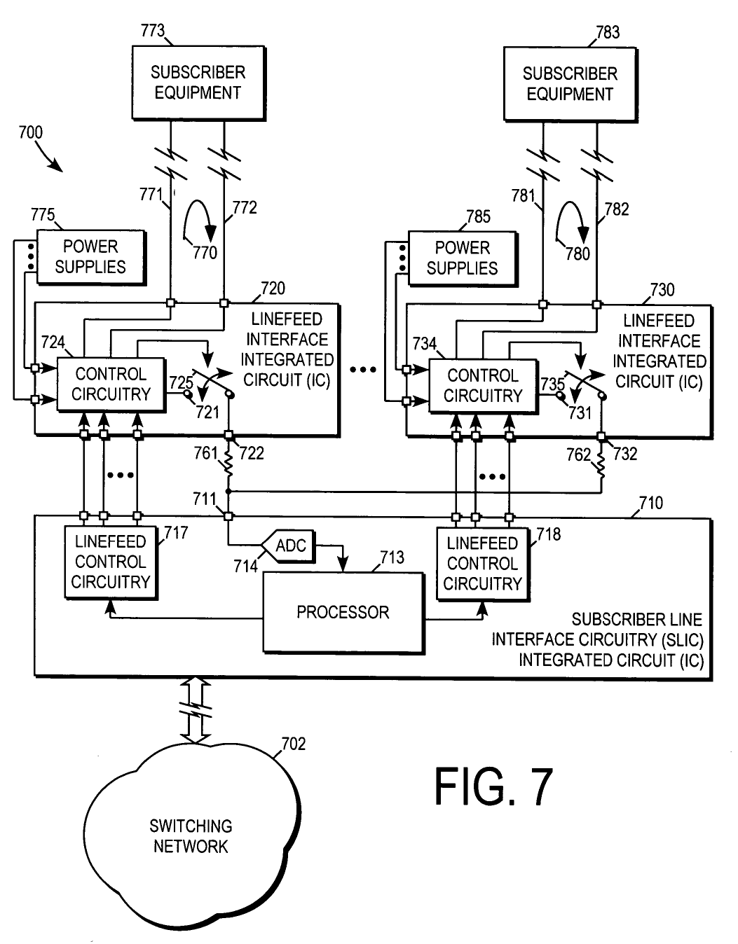

FIG. 7 illustrates, for one or more embodiments, a system 700 having selective analog signal sensing from a plurality of linefeed interface integrated circuits 720 and 730 using a common input node 711 for a subscriber line interface circuitry (SLIC) integrated circuit 710. SLIC integrated circuit 710 and linefeed interface integrated circuits 720 and 730 generally correspond to integrated circuits 110, 120, and 130, respectively.

SLIC integrated circuit 710 and linefeed interface integrated circuits 720 and 730 for one embodiment may provide a communications interface between a switching network 702 and subscriber loops 770 and 780. Switching network 702 for one embodiment may be a digital switching network for a larger telecommunications network, such as the Public Switched Telephone Network (PSTN). SLIC integrated circuit 710 and linefeed interface integrated circuits 720 and 730 may be used for any suitable application such as, for example and without limitation, digital loop carriers; Central Office telephony; pair gain remote terminals; wireless local loop (WLL); digital subscriber line (DSL), coder/decoder (codec), and/or wireless voice-over-broadband systems; cable telephony; private branch exchange (PBX), Internet protocol PBX (IP-PBX), and/or key telephone systems; Integrated Services Digital Network (ISDN), Ethernet, and/or Universal Serial Bus (USB) terminal adapters; and/or Integrated Voice and Data (IVD) systems.

Subscriber loop 770 for one embodiment, as illustrated in FIG. 7, is defined by a first line 771, a second line 772, and subscriber equipment 773. For one embodiment where SLIC integrated circuit 710 and linefeed interface integrated circuit 720 provide an analog telephone interface, first line 771 is called a tip line and second line 772 is called a ring line. Subscriber equipment 773 is electrically coupled to first line 771 and second line 772 and may comprise any suitable number of devices comprising any suitable circuitry to transmit and receive any suitable signals over first line 771 and second line 772 in any suitable manner. Subscriber equipment 773 for one embodiment may comprise any suitable customer premises equipment (CPE), such as an analog telephone for example.

SLIC integrated circuit 710 and linefeed interface integrated circuit 720 for one embodiment may be coupled to receive signals on subscriber loop 770 from subscriber equipment 773 and forward the received signals or transform and transmit the received signals to switching network 702. SLIC integrated circuit 710 and linefeed interface integrated circuit 720 for one embodiment may be coupled to receive signals from switching network 702 and forward the received signals or transform and transmit the received signals on subscriber loop 770 to subscriber equipment 773. For one embodiment where SLIC integrated circuit 710 and linefeed interface integrated circuit 720 provide an analog telephone interface to subscriber loop 770 and where switching network 702 is a digital switching network, SLIC integrated circuit 710 and linefeed interface integrated circuit 720 may receive voiceband communications transmitted from subscriber equipment 773 in the form of low voltage analog signals on subscriber loop 770 and transform them into corresponding digital data signals for transmission to switching network 702. SLIC integrated circuit 710 and linefeed interface integrated circuit 720 for one embodiment may also transform digital data signals received from switching network 702 into corresponding low voltage analog signals for transmission on subscriber loop 770 to subscriber equipment 773.

Subscriber loop 780 for one embodiment, as illustrated in FIG. 7, is defined by a first line 781, a second line 782, and subscriber equipment 783. For one embodiment where SLIC integrated circuit 710 and linefeed interface integrated circuit 730 provide an analog telephone interface, first line 781 is called a tip line and second line 782 is called a ring line. Subscriber equipment 783 is electrically coupled to first line 781 and second line 782 and may comprise any suitable number of devices comprising any suitable circuitry to transmit and receive any suitable signals over first line 781 and second line 782 in any suitable manner. Subscriber equipment 783 for one embodiment may comprise any suitable customer premises equipment (CPE), such as an analog telephone for example.

SLIC integrated circuit 710 and linefeed interface integrated circuit 730 for one embodiment may be coupled to receive signals on subscriber loop 780 from subscriber equipment 783 and forward the received signals or transform and transmit the received signals to switching network 702. SLIC integrated circuit 710 and linefeed interface integrated circuit 730 for one embodiment may be coupled to receive signals from switching network 702 and forward the received signals or transform and transmit the received signals on subscriber loop 780 to subscriber equipment 783. For one embodiment where SLIC integrated circuit 710 and linefeed interface integrated circuit 730 provide an analog telephone interface to subscriber loop 780 and where switching network 702 is a digital switching network, SLIC integrated circuit 710 and linefeed interface integrated circuit 730 may receive voiceband communications transmitted from subscriber equipment 783 in the form of low voltage analog signals on subscriber loop 780 and transform them into corresponding digital data signals for transmission to switching network 702. SLIC integrated circuit 710 and linefeed interface integrated circuit 730 for one embodiment may also transform digital data signals received from switching network 702 into corresponding low voltage analog signals for transmission on subscriber loop 780 to subscriber equipment 783.

SLIC integrated circuit 710 for one or more embodiments may be a relatively low voltage device and may be coupled to control linefeed interface integrated circuit 720 and/or 730 to help control relatively higher voltages to operate subscriber equipment 773 and/or 783, respectively. SLIC integrated circuit 710 and linefeed interface integrated circuits 720 and 730 for one embodiment may comprise any suitable circuitry to perform any suitable one or more BORSCHT functions and/or any other suitable one or more functions. BORSCHT is an acronym for battery feed, overvoltage protection, ring, supervision, coder/decoder (codec), hybrid, and test.

SLIC integrated circuit 710 for one or more embodiments may control linefeed interface integrated circuit 720 to switch between or among different power supply levels based on, for example, the operation state of SLIC integrated circuit 710 and/or the voltage across subscriber loop. SLIC integrated circuit 710 for one embodiment may generate one or more control signals to control the power supplied to linefeed interface integrated circuit 720. Linefeed interface integrated circuit 720 for one or more embodiments, as illustrated in FIG. 7, may comprise control circuitry 724 coupled to receive one or more power signals in a selective manner from power supplies 775 and coupled to receive one or more control signals from SLIC integrated circuit 710 to provide power to linefeed interface integrated circuit 720 at a desired level in accordance with one or more control signals from SLIC integrated circuit 710. Control circuitry 724 outputs a signal corresponding to the power supplied to linefeed interface integrated circuit 720 at a power supply node 721.

SLIC integrated circuit 710 for one or more embodiments may control linefeed interface integrated circuit 730 to switch between or among different power supply levels based on, for example, the operation state of SLIC integrated circuit 710 and/or the voltage across subscriber loop. SLIC integrated circuit 710 for one embodiment may generate one or more control signals to control the power supplied to linefeed interface integrated circuit 730. Linefeed interface integrated circuit 730 for one or more embodiments, as illustrated in FIG. 7, may comprise control circuitry 734 coupled to receive one or more power signals in a selective manner from power supplies 785 and coupled to receive one or more control signals from SLIC integrated circuit 710 to provide power to linefeed interface integrated circuit 720 at a desired level in accordance with one or more control signals from SLIC integrated circuit 710. Control circuitry 734 outputs a signal corresponding to the power supplied to linefeed interface integrated circuit 730 at a power supply node 731.

SLIC integrated circuit 710 for one or more embodiments may help selectively sense power supply nodes 721 and 731 of linefeed interface integrated circuits 720 and 730 using common input node 711 for SLIC integrated circuit 710 to help monitor and control voltage and current on subscriber loops 770 and 780, respectively, and to help protect linefeed interface integrated circuits 720 and 730 from excessive power dissipation and thermal overload conditions.

SLIC integrated circuit 710 for one or more embodiments may help selectively sense power supply nodes 721 and 731 of linefeed interface integrated circuits 720 and 730 similarly as integrated circuit 110 helps selectively sense nodes 121 and 131 of integrated circuits 120 and 130 in accordance with flow diagram 200 of FIG. 2, flow diagram 300 of FIG. 3, and/or flow diagram 600 of FIG. 6.

SLIC integrated circuit 710 for one or more embodiments may comprise a processor 713 coupled to control linefeed control circuitry 717 to generate one or more control signals to couple power supply node 721 to common input node 711. Processor 713 is also coupled to control linefeed control circuitry 718 to generate one or more control signals to couple power supply node 731 to common input node 711.

Linefeed interface integrated circuit 720 for one or more embodiments may comprise control circuitry 724 and a switch 725 coupled between power supply node 721 and an output node 722 coupled to common input node 711. Control circuitry 724 may be coupled to receive one or more control signals from SLIC integrated circuit 710 and to activate switch 725 in response to one or more control signals to couple power supply node 721 to common input node 711.

Linefeed interface integrated circuit 730 for one or more embodiments may comprise control circuitry 734 and a switch 735 coupled between power supply node 731 and an output node 732 coupled to common input node 711. Control circuitry 734 may be coupled to receive one or more control signals from SLIC integrated circuit 710 and to activate switch 735 in response to one or more control signals to couple power supply node 731 to common input node 711.

SLIC integrated circuit 710 for one or more embodiments may comprise an analog-to-digital converter (ADC) 714 coupled to common input node 711 to sense an analog signal at common input node 711 based on the power signal at the power supply node 721 or 731 coupled to common input node 711. ADC 714 converts the analog signal at common input node 711 to one or more digital signals. ADC 714 for one or more embodiments may be coupled to processor 713 to transmit such digital signal(s) to processor 713. Processor 713 for one or more embodiments may comprise one or more registers to store such digital signal(s) to help monitor power supply levels at linefeed interface integrated circuits 720 and 730.

System 700 for one or more embodiments as illustrated in FIG. 7 may comprise a resistor 761 coupled between common input node 711 and output node 722 to which power supply node 721 may be selectively coupled and a resistor 762 coupled between common input node 711 and output node 732 to which power supply node 731 may be selectively coupled to help scale the signal to be sensed by SLIC integrated circuit 710. System 700 for one or more other embodiments may comprise, in addition to or in lieu of resistors 761 and 762, one or more resistors having one end coupled in common to output node 722 and/or 732 and another end coupled to common input node 711.

Although described in connection with using plural power supplies 775, for example, to supply power at different levels to linefeed interface integrated circuit 720, system 700 for one or more other embodiments may use a variable power supply controlled by SLIC integrated circuit 710 to supply power at a power supply input node of linefeed interface integrated circuit 720. SLIC integrated circuit 710 and linefeed interface integrated circuit 720 may then comprise any suitable circuitry to allow SLIC integrated circuit 710 to sense that power supply input node using common input node 711.

Although described in connection with sensing power supply nodes, SLIC integrated circuit 710 and linefeed interface integrated circuits 720 and 730 may comprise any suitable circuitry to allow SLIC integrated circuit 710 to sense any suitable one or more nodes such as a tip line node or a ring line node, for example, using common input node 711.

In the foregoing description, one or more embodiments of the present invention have been described. It will, however, be evident that various modifications and changes may be made thereto without departing from the broader spirit or scope of the present invention as defined in the appended claims. The specification and drawings are, accordingly, to be regarded in an illustrative rather than a restrictive sense.

What is claimed is:

1. A method comprising:
generating by a first integrated circuit one or more control signals to couple a select one of a plurality of nodes of a plurality of second integrated circuits to a common input node for the first integrated circuit; and
sensing by the first integrated circuit an analog signal at the common input node based on a signal at the coupled select node.

2. The method of claim 1, comprising:
generating by the first integrated circuit one or more control signals to couple another select node of another second integrated circuit to the common input node; and
sensing by the first integrated circuit an analog signal at the common input node based on a signal at the coupled other select node.

3. The method of claim 1, comprising:
generating by the first integrated circuit one or more control signals to couple another select node of a same second integrated circuit to the common input node; and
sensing by the first integrated circuit an analog signal at the common input node based on a signal at the coupled other select node.

4. The method of claim 1, wherein the select node is a power supply node.

5. The method of claim 1, wherein the sensing the analog signal comprises sensing a scaled signal of the signal at the coupled select node.

6. The method of claim 1, wherein the sensing the analog signal comprises receiving the analog signal at the common input node and converting the analog signal to one or more digital signals.

7. An integrated circuit comprising:
control circuitry to generate and output one or more control signals to couple a select one of a plurality of nodes of a plurality of other integrated circuits to a common input node; and
sensing circuitry to sense an analog signal at the common input node based on a signal at the coupled select node.

8. The integrated circuit of claim 7, wherein the control circuitry is to generate one or more control signals to couple another select node of another integrated circuit to the common input node; and
wherein the sensing circuitry is to sense an analog signal at the common input node based on a signal at the coupled other select node.

9. The integrated circuit of claim 7, wherein the control circuitry is to generate one or more control signals to couple another select node of a same integrated circuit to the common input node; and
wherein the sensing circuitry is to sense an analog signal at the common input node based on a signal at the coupled other select node.

10. The integrated circuit of claim 7, wherein the select node is a power supply node.

11. The integrated circuit of claim 7, wherein the sensing circuitry is to sense a scaled signal of the signal at the coupled select node.

12. The integrated circuit of claim 7, wherein the sensing circuitry comprises an analog-to-digital converter to convert the analog signal to one or more digital signals.

13. A system comprising:
a first integrated circuit; and
a plurality of second integrated circuits coupled to the first integrated circuit;
wherein the first integrated circuit comprises control circuitry to generate and output one or more control signals to couple a select node of one of the plurality of second integrated circuits to a common input node and sensing circuitry to sense an analog signal at the common input node based on a signal at the coupled select node, and
wherein the one second integrated circuit comprises circuitry to couple the select node to the common input node in response to the one or more control signals.

14. The system of claim 13, wherein the select node is a power supply node.

15. The system of claim 13, comprising one or more resistors coupled between the select node and the common input node.

16. The system of claim 13, wherein the sensing circuitry comprises an analog-to-digital converter to convert the analog signal to one or more digital signals.

17. The system of claim 13, wherein the one second integrated circuit comprises a switch coupled between the select node and the common input node and control circuitry coupled to activate the switch in response to the one or more control signals.

18. The system of claim 13, wherein the one second integrated circuit comprises a multiplexer coupled between the select node and the common input node and control circuitry coupled to control the multiplexer in response to the one or more control signals.

19. The system of claim 13, wherein the one second integrated circuit is a high voltage integrated circuit relative to the first integrated circuit.

20. The system of claim 13, wherein the first integrated circuit is a subscriber line interface circuitry integrated circuit and the one second integrated circuit is a linefeed interface integrated circuit.
